(19) United States
(12) Patent Application Publication
(10) Pub. No.: US 2004/0177161 A1
(43) Pub. Date: Sep. 9, 2004

(54) System and method for distributing digital data services over existing network infrastructure

(76) Inventor: Khoi Hoang, Pleasanton, CA (US)

Correspondence Address: Tamiz Khan, Esq., Prediwave Corp., 48431 Milmont Drive, Fremont, CA, 94538, US

(21) Appl. No.: 10/383,166

(22) Filed: Mar. 5, 2003

(51) Int. Cl. G06F 15/16

(52) U.S. Cl. 709/246

(57) ABSTRACT

The present invention teaches a system for providing digital data services to a client comprising: providing client-generic multicast data including a plurality of multicast groups to a data distribution system, wherein each multicast group includes at least one digital data service; re-formatting the client-generic multicast data in a fast transmission format; transmitting the fastally formatted client-generic multicast data to at least one distribution node; re-formatting the fastally formatted client-generic transmission in a format suitable for client-specific delivery to at least one client; receiving a client request for a selected multicast group at the at least one distribution node from a requesting client; at the at least one distribution node, routing the selected multicast group to the requesting client enabling the requesting client to access a selected digital data service from the multicast group and discard data contained within the selected multicast group not corresponding to the selected digital data service.

### RELATED APPLICATIONS

This application is related to Khoi Nhu Hoang's patent applications entitled UNIVERSAL STB ARCHITECTURES AND CONTROL METHODS filed on May 30, 2001, SYSTEMS AND METHODS FOR PROVIDING VIDEO ON DEMAND SERVICES FOR BROADCASTING SYSTEMS filed on May 31, 2000, bearing application Ser. No. 09/584,832, METHODS FOR PROVIDING VIDEO ON DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, each of which being hereby incorporated herein by reference.

### BRIEF DESCRIPTION OF THE INVENTION

1. Field of the Invention

This invention relates generally to digital data broadcast systems. In particular, this invention relates to digital broadcast systems for transmitting video-on-demand (VOD) programs and other digital data services to large numbers of end users over existing network infrastructure.

2. Background of the Invention

Currently the standard distribution system for delivering data-on-demand is the client server model, with the widest implementation of the client server model being the Internet. One limitation of conventional client server architectures such as the internet, is that a data server can only provide information to a limited number of clients because it must allocate bandwidth for each client and expend processing power to address data to each requesting client.

Prior Art FIG. 1 shows a simplified prior art functional block diagram of a Data On Demand (DOD) system. A conventional data server 10 is connected to a computer network via a service provider 12, which in turn is communicatively connected to a plurality of users 16 via communication nodes 14. In order for conventional server 10 to provide DOD data files such as video-on-demand (VOD) programs to a user 16, the client must request a selected data file. This request (not shown) is relayed through at least one node 14 to the headend 12, and finally to conventional data server 10. After receiving the request, data server 10 provides packets of data comprising the requested file back to the requesting user 16 via the headend 12 and node 14. The user 16 receives the data packets (not shown) and views the video program.

Prior Art FIG. 2 shows a flow chart diagram of a typical client server request process at 50. In a step 52, the user 16 (FIG. 1) sends a request to the data server 10 via intervening nodes and an headend. In step 54, the conventional server retrieves the data specified in the request. In step 56, the data server transmits the requested data to the requesting user. In step 58, the user accesses the requested data. Though there are subtle variations to this method, all existing DOD distributions perform these steps.

There are many limitations of current DOD broadcast systems used to transmit large numbers data files to a large number of users. Some progress has been made by utilizing fiber-optic transmission systems, which utilize standard formats such as synchronous digital hierarchy (SDH) and synchronous optical network (SONET). Though these fiber-optic systems can provide greater transmission bandwidth, they cannot reduce the amount of request processing required by data servers. Furthermore, there is no established method for delivering DOD and digital video services (DVB, HDTV, etc.) integrating SDH/SONET with Ethernet distribution systems. The transmission bandwidth required by conventional DOD server systems is dependent upon the number of DOD users, with large numbers of users requiring proportionally more bandwidth. Conventional DOD server systems require the allocation of server processing resources in proportion the number of user requests they receive. Existing systems do not efficiently take advantage of new fiber-optic transmission systems.

Therefore, what is needed is a DOD broadcast system capable of providing DOD services to users without requiring transmission bandwidth proportional to the number of receiving users. Further needed is a DOD server system which does not require processing resources proportional to the number of requests for data received. Further needed is a DOD broadcast system that efficiently makes use of new fiber-optic transmission systems. Further needed is a more bandwidth efficient method of providing DOD services to end users.

### SUMMARY OF THE INVENTION

The present invention provides a DOD broadcast system capable of providing DOD services to users without requiring transmission bandwidth proportional to the number of receiving users. Further provided is a DOD server system, which does not require processing resources proportional to the number of requests for data received. Further provided is a DOD broadcast system that efficiently makes use of new fiber-optic transmission systems. Further provided is a more bandwidth efficient method of providing VOD services by transmitted client-generic data to intermediate distribution nodes for client-specific delivery to end users.

Briefly, one aspect of the present invention is embodied in a method for providing digital data services to a client comprising the acts of: providing client-generic multicast data including a plurality of multicast groups to a data distribution system, wherein each multicast group includes at least one digital data service; re-formatting the client-generic multicast data in a fiber-optic transmission format; transmitting the fiber-optically formatted client-generic multicast data to at least one distribution node; re-formatting the fiber-optically formatted client-generic transmission in a format suitable for client-specific delivery to at least one client; receiving a client request for a selected multicast group at the at least one distribution node from a requesting client; at the at least one distribution node, routing the selected multicast group to the requesting client enabling the requesting client to access a selected digital data service from the multicast group. In accordance with one embodiment, the fiber-optic transmission format is chosen from the group consisting essentially of the SDH, SONET, ATM and PON formats. In accordance with another embodiment, the selected multicast group is provided to requesting clients in an Ethernet transmission format.

Another embodiment of the present invention teaches a digital data broadcasting system for providing digital data services to a large number of clients comprising: a data server operative to produce a client-generic multicast data stream including a plurality of multicast groups, each including at least one digital data program, wherein the plurality of multicast groups includes an EPG multicast group; a data distribution system operative to receive the client-generic multicast data stream and transmit the client-generic data stream in a fiber-optic transmission format to a data distribution node; wherein the data distribution node is operative to provide the EPG multicast group to a plurality of subscribing clients, the EPG multicast group enabling a requesting client to select a multicast groups corresponding to desired digital data programs, wherein the data distribution node is further operative to receive a client request for the selected multicast groups via at least one communications link; and wherein the data distribution node is operative to route the selected multicast groups to the requesting client in response to the client request, enabling the requesting client to receive the multicast groups and access the desired digital data programs. In accordance with one embodiment, the data distribution system includes an Ethernet to synchronous digital hierarchy (SDH) converter for converting the client generic data stream to the fiber-optic transmission format for transmission to the data distribution node.

In one embodiment of the present invention, an icon corresponding to each data service is displayed via the EPG such that a user may select the data service by selecting the displayed icon. In another embodiment the EPG comprises an EPG multicast group included in the client-generic DOD transmission, and wherein the EPG enables the requesting client to request the selected multicast groups corresponding to the selected digital data services.

It should be understood that the term set-top-box (STB) is being used as a generic term referring to a variety of devices including intelligent televisions, computers and other devices, which include an on-board processor for accessing digital video data. It should also be understood that Ethernet, or any other high bandwidth short range communications medium could be used to distribute data to end users in accordance with the present invention.

### BRIEF DESCRIPTION OF THE DRAWINGS

Prior Art FIG. 1 shows a simplified functional block diagram of a conventional client-server data distribution system in accordance with the prior art;

Prior art FIG. 2 is a flow chart diagram of a typical client-server request process in accordance with the prior art;

FIG. 3 is a simplified functional block diagram of a digital data distribution system in accordance with one embodiment of the present invention;

FIG. 4 is flow chart diagram of an exemplary process for providing DOD and digital broadcast services in accordance with one embodiment of the present invention;

FIG. 5 is a schematic block diagram of the architecture of an exemplary multicast digital data server in accordance with one embodiment of the present invention;

FIG. 6 is a schematic block diagram illustrating the architecture of an exemplary distribution node in accordance with one embodiment of the present invention;

FIG. 7 is a schematic block diagram illustrating a universal set-top-box (STB) receiver for use by digital data service clients in accordance with one embodiment of the invention; and

FIG. 8 illustrates an STB process at 700 for selecting and receiving digital data services in accordance with one embodiment of the present invention.

### DETAILED DESCRIPTION OF THE INVENTION

The present invention provides a DOD and digital broadcast system capable of providing DOD and digital broadcast services to users without requiring transmission bandwidth to increase with the number of receiving users. Further provided is a DOD server system, which does not require processing resources increase with the number of requests for data received. Further provided is a DOD broadcast system that efficiently makes use of new fiber-optic transmission systems such as DWDM. Further provided is a more bandwidth efficient method of providing VOD services by transmitting client-generic data to intermediate distribution nodes for client-specific delivery to end users.

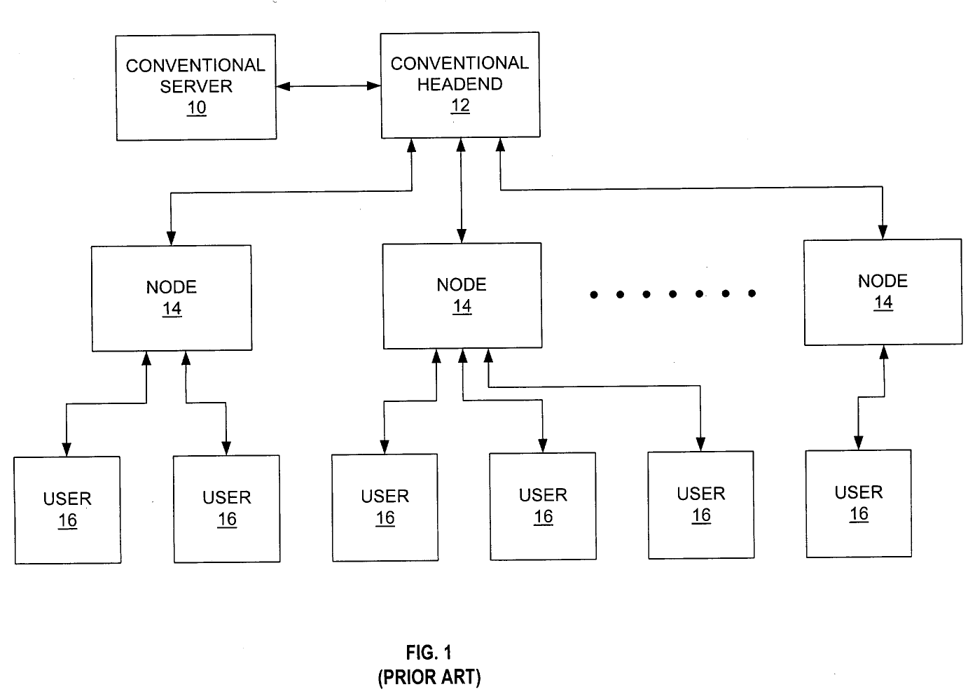

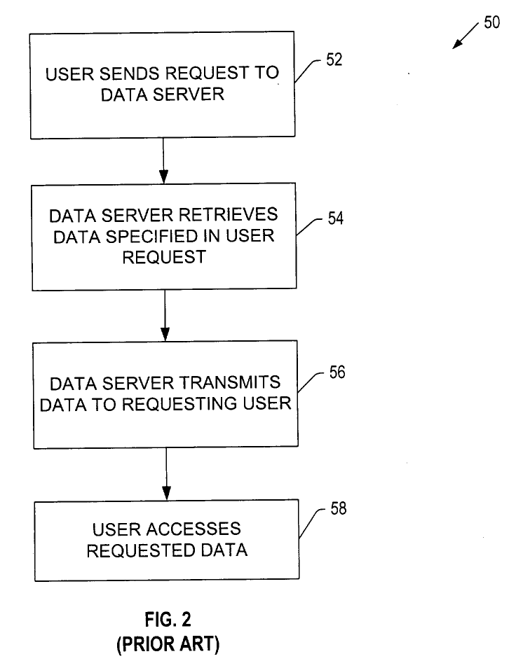

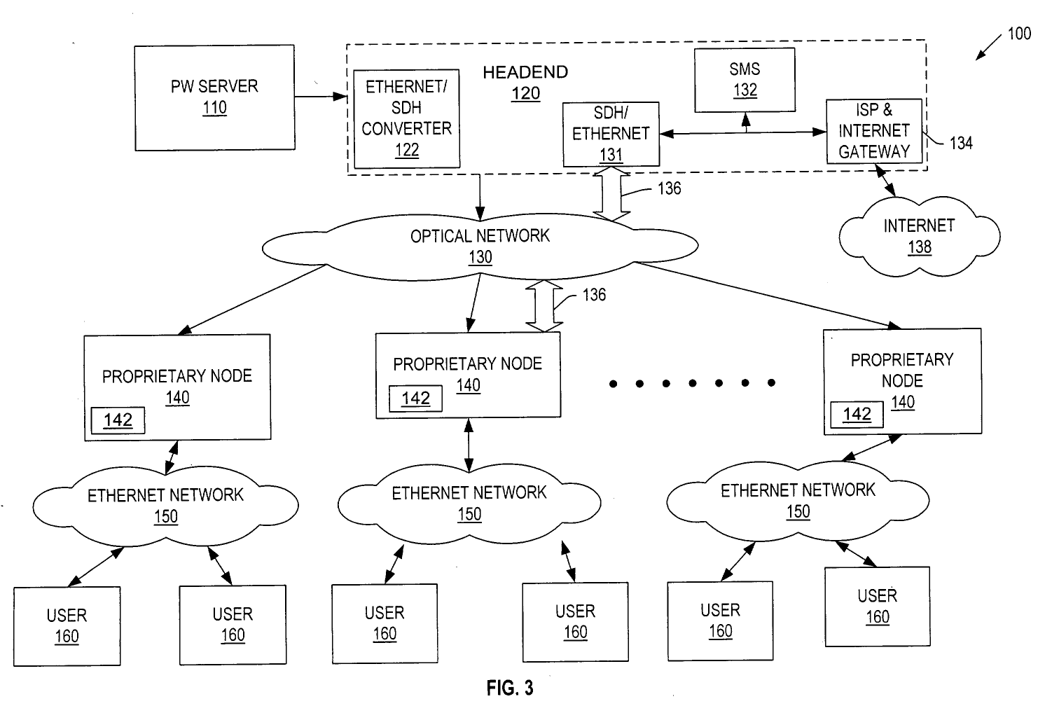

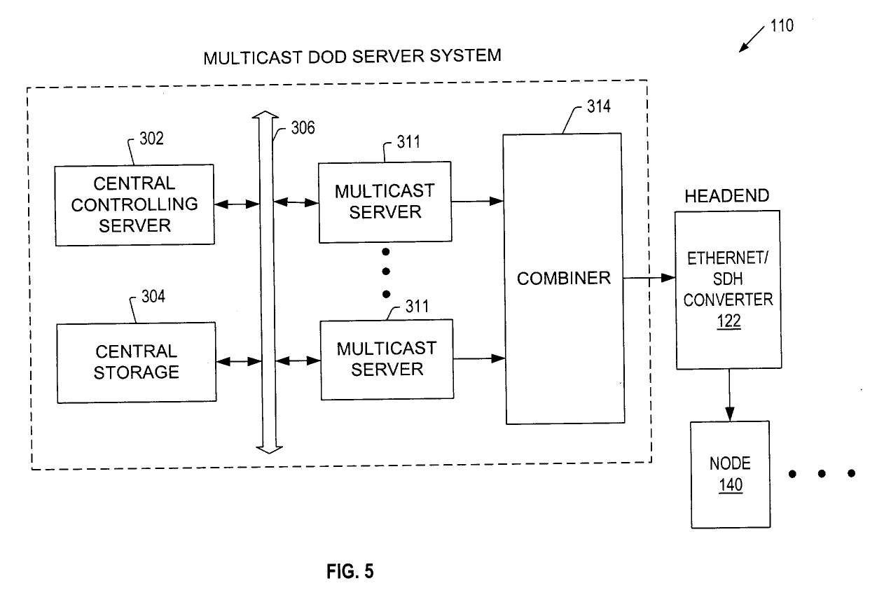

FIG. 3 shows a simplified functional block diagram of a digital data distribution system 100 in accordance with one embodiment of the present invention. Though no network topology is specified, any suitable network architecture may be used for the communications links throughout the digital data distribution system 100 such as tree, ring, mesh, and star network topologies. At the heart of the digital data distribution system 100 is the multicast DOD/broadcast server 110. In accordance with a preferred embodiment multicast server 110 provides a plurality of multicast “client-generic” data streams including a wide variety of digital data programs including television broadcasts, VOD movies, computer programs, etc. This multicast data stream will include a plurality of multicast groups, including an EPG group, multiple VOD groups and multiple broadcast television groups, etc. In accordance with a preferred embodiment this multicast “client-generic” data stream is formatted as an Ethernet data transmission. The function of multicast server 110 will be further explained with reference to FIG. 5 below.

In accordance with a preferred embodiment, multicast headend 120 receives the client-generic Ethernet multicast transmission, including all multicast groups from the multicast Broadcast server 110. In accordance with a preferred embodiment headend 120 includes an Ethernet/SDH converter 122, which converts the client-generic Ethernet multicast transmission into a client-generic SDH multicast transmission. In accordance with alternative embodiments, the Ethernet transmission could be converted to SONET, PON (passive optical network), ATM or any other high speed transmission format. In accordance with yet another embodiment, a satellite transmission format my be used such as a DVB-S format or other suitable format such as DVB-ASI.

In accordance with an exemplary embodiment multicast headend 120 transmits the “client-generic” multicast SDH signal containing all the multicast groups to a plurality of nodes 140 via a fiber-optic communications network 130. In accordance with a preferred embodiment, no requests for specific data need to be made either to the multicast server 110, or the headend 120 because the same multicast data stream is provided to each node 140 in a uni-directional manner. Thus server processing resources required for receiving data requests, retrieving requested data, and addressing requested data to end users are virtually eliminated. Greatly reducing or eliminating data server and headend processing and routing requirements, thereby allowing a single data server to provide data to an unlimited number of users, compared to conventional bi-directional data server/headend systems, which can only provide service to a finite number of clients. Such a server system could service an infinite number of distribution nodes 140, and only have to generate transmission bandwidth sufficient for the single “client-generic” multicast transmission. In accordance with one embodiment, each multicast group will be transmitted on a separate optical frequency band to enable simplified optical routing and de-multiplexing of each multicast group.

In an exemplary embodiment, each node 140 includes an SDH to Ethernet converter 122 (or other appropriate converter), for converting the multicast transmission received from the headend 120 back into an Ethernet format suitable for distributing to users via conventional Ethernet communications, or any suitable communications medium. In accordance with alternative embodiments, converter 122 may instead consist of a ATM to Ethernet converter, a SONET to Ethernet converter, and SDH to xDSL converter, or any other converter, or combination of converters suitable for converting the high bandwidth signal from headend 120 to a format suitable for client-specific distribution to end users.

In accordance with one embodiment, each node 140 is further operative to receive requests for selected multicast groups from a plurality of users 160 via an Ethernet network 150. In response to each such request a node 140 routes the selected multicast group from the converted “client-generic” multicast data stream to the requesting user. Thus each node 140 will provide the data retrieval and routing (Ethernet, or optical routing) functions traditionally performed by conventional data servers greatly increasing data distribution efficiency over conventional systems. In accordance with an alternative embodiment, an optical router will be used to route the selected data groups. In accordance with a preferred embodiment, requests and delivery of data are via an Ethernet communications link. In accordance with a preferred embodiment, digital data is distributed to requesting users via existing communications infrastructure. In accordance with one embodiment, node 140 also serves as an Internet gateway. In accordance with another alternative embodiment, nodes 140 may use various output formats other than Ethernet such that any two nodes 140 may be providing data to users in two or more different transmission formats. Such formats may include various wireless transmission formats, or other formats not yet contemplated. Thus a first node (not shown) could provide DOD services in an Ethernet format, while a second node (not shown) could provide DOD services in a proprietary wireless format such as that used by various wireless information providers.

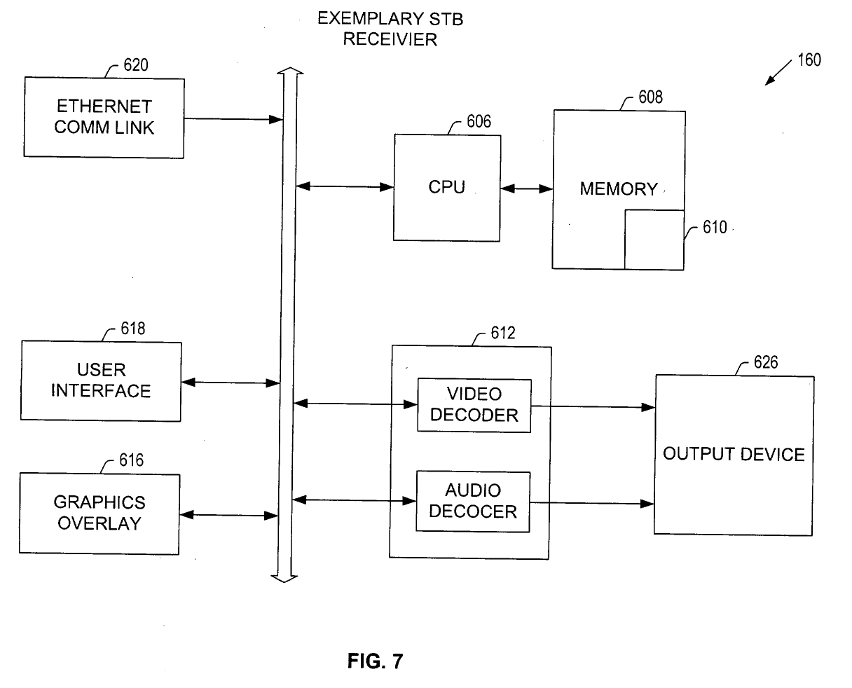

In accordance with a preferred embodiment node 140 provides an electronic program guide (EPG) data stream to all subscribing users, which allows each user to select digital data services which are available from server 110. In accordance with the preferred embodiment, the EPG program is included as part of an EPG multicast group, and contains information on all multicast groups within the non “client-specific” multicast data stream generated by server 110. The operation of node 140 is described in more detail with reference to FIG. 7 below.

In accordance with one embodiment, headend 120 also includes a SDH to Ethernet converter 131 for conducing non-client generic communication with users 160 via bi-directional communications links 136. These bi-directional non-client generic communications could be used to provide Internet access to the users 160 via Internet gateway 134. These bi-directional communications could also be used to track and control client activities via subscriber management system (SMS) 132. SMS 132 could be used to restrict access to services, track client activity, and for client billing. Communications links 136 could enable SMS 132 to also manage clients accounts, STBs, access to broadcast services, etc.

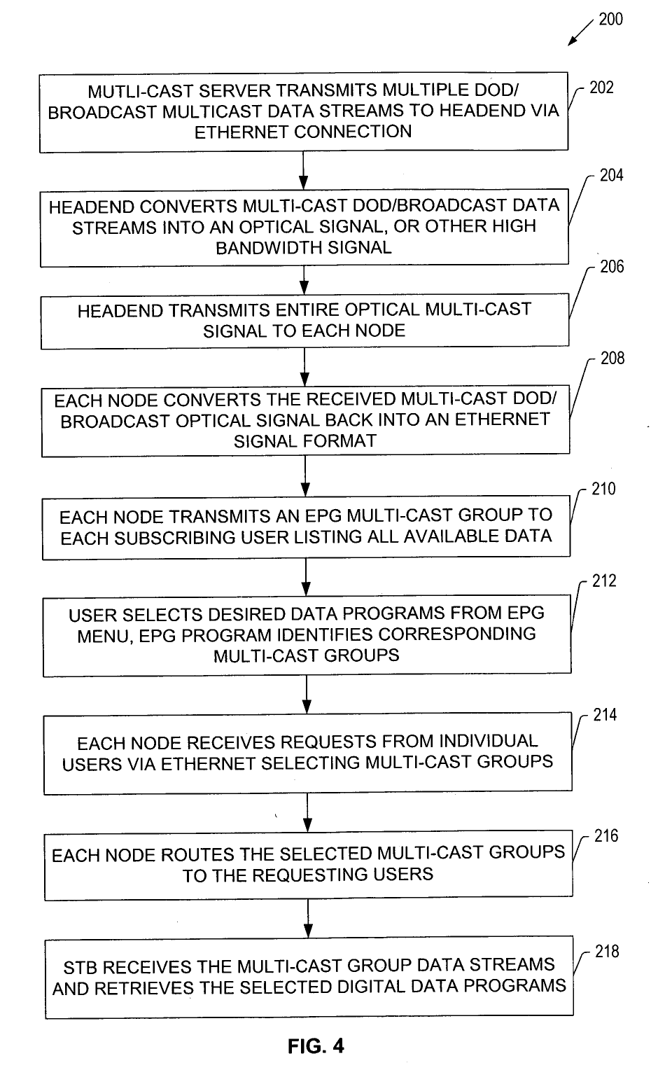

FIG. 4 shows an exemplary process at 200 for providing VOD and digital data services in accordance with one embodiment of the present invention. The process begins at a step 202, at which the multicast server transmits multiple DOD/broadcast multicast data streams to a multicast headend via an Ethernet communication link. In order to accommodate the high volume of data in such a data stream, multiple multicast data streams are required, each stream containing 2-30 Mb/s of data. Then in a step 204, the headend converts the client-generic multicast data transmission into an optical signal such as an SDH formatted transmission, or other high transmission bandwidth format. Various high bandwidth formats may include SDH, SONET, ATM, DVB-S, etc.

In a step 206 the headend transmits the entire optically formatted “client-generic” data signal to a plurality of distribution nodes 140 (FIG. 3). In a step 208, each distribution node 140 converts the received “client-generic” multicast data signal back into an Ethernet format, or other format suitable for “client-specific” delivery to requesting users 160 (FIG. 3).

In step 210, distribution nodes 140 separate out an EPG multicast group from the received data, and route this EPG multicast group to all subscribing users. In accordance with a preferred embodiment, the EPG multicast group is transmitted to all subscribing users, and updated continuously. In accordance with a preferred embodiment, the EPG multicast group includes an EPG program listing all digital data services available.

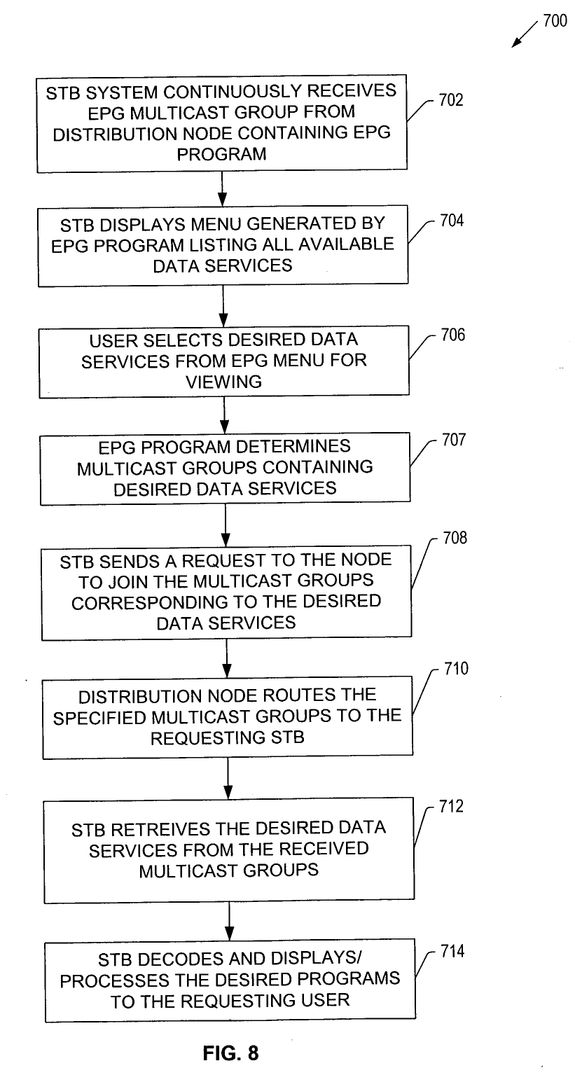

In a step 212, a user selects a desired data program from an EPG menu. The EPG program identifies the multicast group containing the desired data program and sends a request to join the appropriate multicast group to the node. In accordance with one embodiment, the EPG will run on an STB system capable of receiving several multicast groups as necessary to provide desired services within limits determined by available bandwidth and STB processing power. In this way an exemplary STB could view multiple VOD/DB programs with picture in picture, or record several programs while viewing another. The function and structure of an exemplary STB are described in more detail with reference to FIG. 7 and FIG. 8 below.

In step 214, requests for selected multicast groups are received by each node. In response to these requests, each node 140 (FIG. 3) routes each requested multicast group to the appropriate requesting user in step 216. In step 218, the requesting user STB receives the requested multicast groups and retrieves the desired data programs from the multicast groups. As stated above, an STB may request and receive several multicast group streams within the limits of the STBs processing power and connection bandwidth.

FIG. 5 illustrates the architecture of an exemplary multicast data server 110 in accordance with one embodiment of the present invention. The data server 110 includes a plurality of multicast stream servers 311, a combiner amplifier 314, a central controlling server 302, and a central storage 304, coupled as illustrated through a data bus 306. As will be described below, the central controlling server 302 controls off-line operation of the multicast stream servers 311, as well as initiating real-time transmission once the multicast stream servers 311 are ready. The central storage 304 typically stores data files in a digital format. However, any suitable mass persistent data storage device may be used.

In an exemplary embodiment, data files stored in the central storage 304 are accessible via a standard network interface (e.g., Ethernet connection) by the central controlling server 302, or directly from an MPEG encoder or other transmission format. The multicast stream servers 311 provide data that is retrieved from the central storage 304 in accordance with instructions from the central controlling server 302. The retrieval of digital data and the scheduling of transmission of the digital data for DOD is performed “off-line” to fully prepare each multicast stream server 311 for real-time data transmission. Each multicast stream server 311 informs the central controlling server 302 when ready to provide data, at which point the central controlling server 302 can control the multicast stream servers 311 to begin data transmission.

In a preferred embodiment, the central controlling server 302 includes a graphics user interface (not shown) to enable a service provider to schedule data delivery by a drag-and-drop operation. Further, the central controlling server 302 authenticates and controls the multicast stream servers 310 to start or stop according to delivery matrices. Systems and methods for providing uni-directional DOD broadcast matrices are taught in Khoi Hoang's patent application entitled SYSTEMS AND METHODS FOR PROVIDING VIDEO ON DEMAND SERVICES FOR BROADCASTING SYSTEMS filed on May 31, 2000, bearing application Ser. No. 09/584,832, which is incorporated herein by reference.

In a preferred embodiment each multicast stream server 311 is assigned to a plurality of multicast streams and is coupled to the combiner/amplifier 314. The output of each multicast stream server 311 is an Ethernet formatted signal.

The combiner/amplifier 314 amplifies, conditions and combines the received Ethernet signals then outputs the signals to an Ethernet transmission medium to the multicast headend 120 (FIG. 3). In accordance with one embodiment, server combiner/amplifier 314 produces multiple multicast streams of output in order to accommodate the high volume of information. In accordance with one embodiment, each VOD program carried within the multicast output would require in the neighborhood of 2-30 Mb/s of transmission bandwidth, with each VOD program occupying a single multi-cast stream. In accordance with an exemplary embodiment, combiner/amplifier 314 is simply an Ethernet switch used to combine digital data.

The Ethernet/SDH converter 122 converts the combiners Ethernet output streams into a fiber-optic signal, which is routed to all nodes 140. In accordance with one embodiment the SDH signal could potentially carry more than 100 Gb/s of data. Thus, several thousands of multicast streams of 2-30 Mb/s, or more could be combined and carried by a single Dense Wavelength Division Multiplexing (DWDM) fiber-optic line using an SDH, SONET, ATM, or PON format.

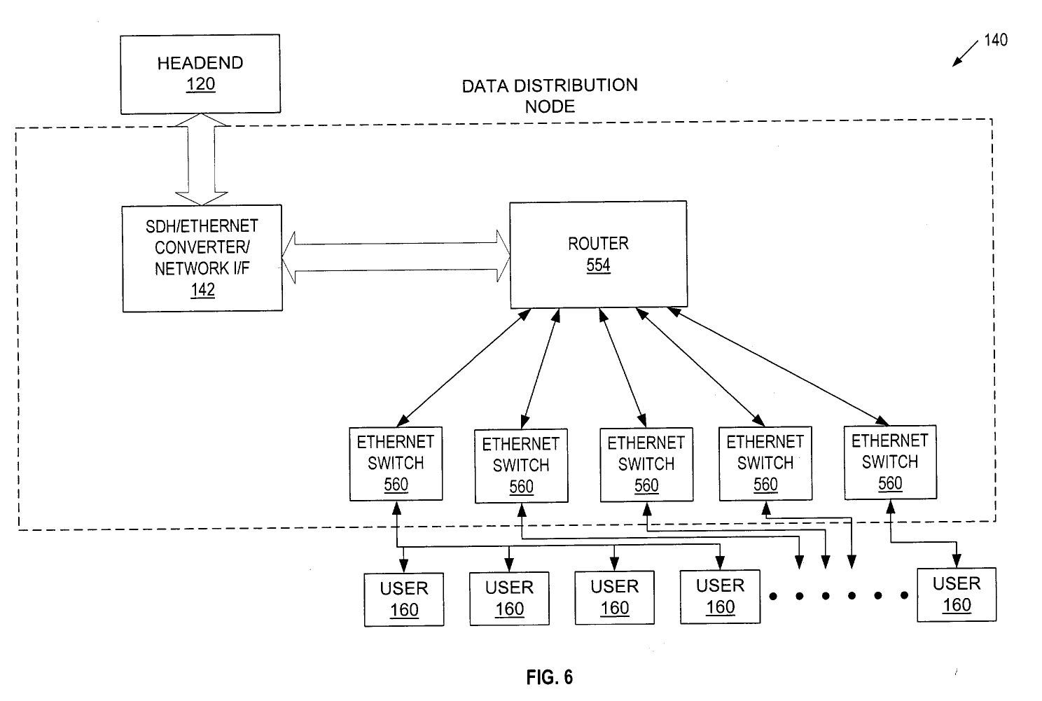

FIG. 6 illustrates the architecture of an exemplary distribution node 140 in accordance with one embodiment of the present invention. The distribution node 140 includes: an SDH/Ethernet converter module 142, router 554, and multiple Ethernet switches 560. The SDH multicast “client-generic” optical data signal is received from the headend 120 (FIG. 3) by SDH/Ethemet converter 142. The SDH/Ethernet converter 142 converts the “client-generic” SDH multicast data signal back into the original Ethernet format made up of the multi-cast groups (or other transmission format appropriate for routing to individual users 160 (FIG. 3). All user STBs 160 will join at least the EPG multicast group. In accordance with an alternative embodiment, other high bandwidth signal formats may be converted to any data format suitable for “client-specific” distribution. Such conversions could include SONET to Ethernet, PON to Ethernet, or any other suitable format conversion.

Router 554 routes an EPG multicast stream to all subscribing users 160 via Ethernet switches 560. The router 554 then receives requests for selected multicast groups from individual user systems 160. Generally the EPG multicast stream will include an EPG program, which will run on user receiver systems 160 enabling individual users to review what digital data services are available and select desired services for viewing. Once a user selects a desired data service, the EPG program will determine which multicast group contains the desired data program, and request that the appropriate multicast group be routed to the user 160. The router 554 then routes the selected multi-cast group to the appropriate user 160 via an Ethernet switch 560. A user STB receives the selected multicast group and retrieves the desired data program. In this way, node 140 can distribute data in a highly efficient manner, simply routing multicast data streams to one or more STBs, which can then use only the data they need. Thus greatly reducing the processing requirements of the entire distribution system over that of conventional client-server models.

In accordance with a preferred embodiment the EPG program is delivered to all subscribing users 160, and updated continuously. In accordance with one embodiment, a user STB can receive as many multicast groups as permitted by the STB processing power and connection bandwidth. In accordance with one embodiment, multiple Ethernet switches 560 are utilized to provide service to a maximum number of users 160.

In accordance with one embodiment, distribution node 140 tracks all requests for multicast groups in order to bill requesting users for receiving data services. Such billing information could be transmitted to the headend SMS (subscriber management system) 132 (FIG. 3), or a third party billing system (not shown) used to generate electronic billing statements, or used to generate bills at any suitable location or format for collection from users.

FIG. 7 illustrates a universal set-top-box (STB) receiver 600 for use by user 160 (FIG. 3) in accordance with one embodiment of the invention. The STB 600 comprises a CPU 606, a local memory 608, a buffer memory 610, a decoder 612 having video and audio decoding capabilities, a graphics overlay module 616, a user interface 618, a communications link 620, and a fast data bus 622 coupling these devices as illustrated. The CPU 606 controls overall operation of the universal STB 600 in order to select data in response to a client's request, decode selected data, decompress decoded data, re-assemble decoded data, store decoded data in the local memory 608 or the buffer memory 610, and deliver stored data to the decoder 612. In an exemplary embodiment, the local memory 608 comprises both non-volatile memory (e.g., a hard drive) and secure memory (e.g., a ROM chip), and the buffer memory 610 comprises volatile memory.

In an exemplary embodiment, when access is granted, the decoder 612 decodes received digital data for display on an output screen. The decoder 612 supports commands from a subscribing client, such as play, stop, pause, step, rewind, forward, etc. The decoder 612 provides decoded data to an output device 624 for use by the client. The output device 624 may be any suitable device such as a television, computer, any appropriate display monitor, a VCR, or the like.

The graphics overlay module 616 enhances displayed graphics quality by, for example, providing alpha blending or picture-in-picture capabilities. In an exemplary embodiment, the graphics overlay module 616 can be used for graphics acceleration during game playing mode, for example, when the service provider provides games-on-demand services using the system in accordance with the invention.

The user interface 618 enables user control of the STB 600, and may be any suitable device such as a remote control device, a keyboard, a smartcard, etc. The communications link 620 provides an additional communications connection. This may be coupled to another computer, or may be used to implement bi-directional communication. The data bus 622 is preferably a commercially available “fast” data bus suitable for performing data communications in a real time manner as required by the present invention. Suitable examples are USB, firewire, etc.

In an exemplary embodiment an EPG multicast stream is constantly received by STB 600, the EPG multicast containing an EPG program, which then resides upon STB 600 and is intermittently updated by data received from distribution nodes 140 (FIG. 3). Exemplary EPG displays all available data programs and a menu for selecting desired programs. A viewer may select a program for viewing by simply selecting an icon corresponding to the desired program listed on such a menu. The EPG program then determines which multicast group stream must be joined in order to acquire the desired program. The EPG then requests that the local node 140 route the appropriate multicast group to the STB 600.

FIG. 8 illustrates an STB process at 700 for selecting and receiving digital data services in accordance with one embodiment of the present invention. In a step 702, STB system 600 receives an EPG multicast group from local distribution node 140 containing an EPG program. In a preferred embodiment, the EPG program contains information on all digital data services available from the multicast server and the contents of each multicast group. In accordance with one embodiment, EPG program includes a description of each digital data service including information such as rating, actors, director, year made, etc. In a step 704, STB 600 displays a selection menu generated by the EPG program. In accordance with one embodiment, the menu displays all available program services including VOD movies, e-books, games, etc. In a step 706, the user selects a desired data service for viewing.

In step 707, the EPG program determines which multicast group contains the selected data service. In accordance with one embodiment, the EPG includes a cross reference table indicating what data services are contained in which multicast groups. In step 708, STB 600 sends a request for the multicast group corresponding to the desired data service to the local distribution node 140. In step 710, distribution node 140 routes the appropriate multicast group to the requesting user. Then in step 712, the STB retrieves the desired data service from the received multicast group. Generally, each program, whether a VOD program, a broadcast program, or a computer program, will occupy a single multicast group. Also, generally a multicast group will only contain a single program, whether the program is a VOD, DOD, broadcast, or other data. The STB then decodes and displays the desired data service to the requesting user in step 714.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

What is claimed is:

1. A method for providing digital data services to a client comprising the acts of:
providing client-generic multicast data including a plurality of multicast groups to a data distribution system, wherein each multicast group includes at least one digital data service;
re-formatting said client-generic multicast data in a fast transmission format;
transmitting said fast formatted client-generic multicast data to at least one distribution node;
re-formatting said fast formatted client-generic transmission in a format suitable for client-specific delivery to at least one client;
receiving a client request for a selected multicast group at said at least one distribution node from a requesting client;
at said at least one distribution node, routing said selected multicast group to said requesting client enabling said requesting client to access a selected digital data service from said multicast group.

2. A method as recited in claim 1, wherein said client-generic multicast data is provided to said data distribution system in an Ethernet format.

3. A method as recited in claim 1, wherein said fast transmission format is chosen from the group consisting essentially of the SDH, SONET, PON and ATM formats.

4. A method as recited in claim 1, wherein said fast transmission format is a synchronous digital hierarchy (SDH) format.

5. A method as recited in claim 1, wherein said fast transmission format is a synchronous optical network (SONET) format.

6. A method as recited in claim 1, wherein said fast transmission format is a passive optical network (PON) format.

7. A method as recited in claim 1, wherein said re-formatting said fast formatted client-generic transmission in a format suitable for client-specific delivery to at least one client includes re-formatting said client-generic transmission in an Ethernet format.

8. A method as recited in claim 3, including re-formatting said fast formatted client-generic transmission in an Ethernet format suitable for client-specific delivery to said at least one client.

9. A method as recited in claim 1, including providing an electronic program guide (EPG) to said at least one client.

10. A method as recited in claim 9, wherein said EPG comprises an EPG multicast group included in said client-generic DOD transmission, and wherein said EPG enables said requesting client to request said selected multicast group corresponding to said selected digital data service.

11. A digital data broadcasting system for providing digital data services to a large number of clients comprising:
a data server operative to produce a client-generic multicast data stream including a plurality of multicast groups, each including at least one digital data program, wherein said plurality of multicast groups includes an EPG multicast group;
a data distribution system operative to receive said client-generic multicast data stream and transmit said client-generic data stream in a fast transmission format to a data distribution node;
wherein said data distribution node is operative to provide said EPG multicast group to at least one subscribing client, said EPG multicast group enabling a requesting client to select a multicast group corresponding to a desired digital data program, wherein said data distribution node is further operative to receive a client request to join said selected multicast group via at least one communications link; and
wherein said data distribution node is operative to route said selected multicast group to said requesting client in response to said client request, enabling said requesting client to receive said multicast group and access said desired digital data program.

12. A digital data broadcasting system as recited in claim 11, wherein said data distribution system includes an Ethernet to synchronous digital hierarchy (SDH) converter for converting said client generic data stream to said fast transmission format for transmission to said data distribution node.

13. A digital data broadcasting system as recited in claim 11, wherein said data distribution system includes an Ethernet to synchronous optical network (SONET) converter for converting said client generic data stream to said fast transmission format for transmission to said data distribution node.

14. A digital data broadcasting system as recited in claim 11, wherein said data distribution system includes an Ethernet to passive optical network (PON) converter for converting said client generic data stream to said fast transmission format for transmission to data distribution node.

15. A digital data broadcasting system as recited in claim 11, wherein said data distribution node includes a synchronous digital hierarchy (SDH) to Ethernet converter for converting said client-generic fast data stream to a format suited to client-specific data distribution.

16. A digital data broadcasting system as recited in claim 11, wherein said data distribution node includes a converter for converting said client-generic multicast data stream to an Ethernet format enabling said data node to distribute said selected multicast group via a client-specific distribution network.

17. A digital data broadcasting system as recited in claim 16, wherein said client-specific distribution network includes the Internet.

18. A digital data broadcasting system as recited in claim 11, wherein said desired digital data program includes a video-on-demand (VOD) theatrical production.

19. A digital data broadcasting system as recited in claim 11, wherein said desired digital data program includes a SDTV television program.

20. A digital data broadcasting system as recited in claim 11, wherein said desired digital data program includes an interactive video game program.

21. A digital data broadcasting system as recited in claim 11, wherein said desired digital data program includes an interactive video-on-demand (VOD) movie.

22. A digital data broadcasting system as recited in claim 11, further comprising a plurality of client receiver systems operative to select said desired digital data program, and provide said corresponding selected multicast group, and provide said client request to said data distribution node.

23. A digital data broadcasting system as recited in claim 22, wherein each said client receiver system includes a set-top-box receiver (STB) including a central processing unit, a memory, a communications link, a user interface and an output port.

24. A digital data broadcasting system as recited in claim 23, wherein said user interface enables a user to interact with interactive video-on-demand (VOD) programs.

25. A digital data broadcasting system as recited in claim 23, wherein said user interface enables a user to select said desired digital data programs from an EPG program running on said central processing unit.

26. A digital data broadcasting system as recited in claim 11, wherein said data distribution node includes a router and a plurality of Ethernet switches connected via a data bus.

27. A digital data broadcasting system as recited in claim 11, wherein said data server includes a plurality of multicast stream servers communicatively coupled to a combiner for combining digital data from said multicast stream servers in said client-generic multicast data stream.

28. A digital data broadcasting system as recited in claim 11, wherein said data server is not required to receive requests for specific digital data files in order to provide DOD data services, and wherein said at least one data distribution node is operative to receive requests for specific multicast groups.

29. A digital data broadcasting system as recited in claim 11, wherein said at least one communications link includes an Ethernet link.

30. A digital data broadcasting system as recited in claim 11, wherein said at least one communications link includes at least one communications means.

31. A digital data broadcasting system as recited in claim 11, further comprising a plurality of headends, each communicatively coupled with a plurality of data distribution nodes via a broadband communications link.

32. A digital data broadcasting system as recited in claim 11, wherein said desired digital data program includes an interactive data-on-demand (DOD) service.

33. A digital data broadcasting system as recited in claim 11, wherein said desired digital data program includes an interactive data service.

34. A digital data broadcasting system as recited in claim 11, wherein said desired digital data program includes an interactive digital broadcast service.

35. A digital data broadcasting system as recited in claim 23, wherein said user interface enables a user to interact with interactive data-on-demand (DOD) programs.

36. A digital data broadcasting system as recited in claim 23, wherein said user interface enables a user to interact with interactive digital service programs.

37. A digital data broadcasting system as recited in claim 23, wherein said user interface enables a user to interact with interactive broadcast programs.

38. A digital data broadcasting system as recited in claim 11, wherein said data distribution system includes an Ethernet to asynchronous transfer mode (ATM) converter for converting said client generic data stream to said fast transmission format for transmission to data distribution node.

39. A digital data broadcasting system as recited in claim 11, wherein said desired digital data program includes a HDTV television program.

40. A digital broadcasting system for providing digital data services to a large number of clients comprising:
a data server operative to produce a client-generic multicast data stream including a plurality of client-specific multicast groups, each including a plurality of digital data services;
a data distribution system operative to receive said client-generic multicast data stream and transmit said data stream in a broadband transmission format to a data distribution node;
wherein said data distribution node is operative to provide an EPG multicast group to at least one client, said EPG multicast group enabling a requesting client to select multicast groups corresponding to a selected digital data services, wherein said data distribution node is further operative to receive a client request for said selected multicast; and
wherein said data distribution node is operative to route said selected multicast groups to said requesting client in response to said client request, enabling said requesting client to receive said multicast groups and access said desired digital data services.

41. A digital broadcasting system as recited in claim 40, wherein said data distribution system includes an Ethernet to satellite format converter for converting said client generic data stream to a broadband transmission format, wherein said broadband data stream is transmitted to said data distribution node via a satellite broadcast system.

42. A digital broadcasting system as recited in claim 40, wherein said data distribution system includes an Ethernet to asynchronous transfer mode (ATM) converter for converting said client generic data stream to a broadband transmission format for transmission to said data distribution node.

43. A digital broadcasting system as recited in claim 40, further comprising a set-top-box (STB) to access said selected digital data service.
